(19) United States
(12) Patent Application Publication
(10) Pub. No.: US 2011/0270745 A1
(43) Pub. Date: Nov. 3, 2011

(54) System and Method for Facilitating Charitable Donations

(76) Inventors: Ayman A. Azzi, Bikfaya (LB); Edward Bennett, Orpington (GB); Samir Chreim, East Weymouth, MA (US)

(21) Appl. No.: 13/099,525

(22) Filed: May 3, 2011

Related U.S. Application Data
(60) Provisional application No. 61/330,446, filed on May 3, 2010.

(51) Int. Cl. G06Q 40/00

(52) U.S. Cl. 705/39

(57) ABSTRACT

A method suitable for electronically facilitating a transaction between a donor and a recipient comprises the steps of: matching the recipient to the donor based on at least one predetermined matching criterion; transferring at least a first portion of a donation amount from the donor to the recipient; and transmitting donor web content to the recipient in response to conditional acceptance by the recipient of at least the first portion of the donation amount.

### CROSS-REFERENCE TO RELATED APPLICATION

The present Application is related to Provisional Patent Application entitled “Advertising and Donations” filed 3 May 2010 and assigned Ser. No. 61/330,446, incorporated herein by reference in its entirety.

### FIELD OF THE INVENTION

This invention relates broadly to a system and method for facilitating charitable donations using electronic methods, such as via the Internet.

### BACKGROUND OF THE INVENTION

As shown in FIG. 1, a search engine 10 may be a web site that displays web pages 12-18 that are responsive to a query provided by a user at a computing or communications device, such as a laptop 20. The laptop 20 is logged onto the Internet 22 and submits the query to the search engine 10 via a host server 24. The search engine 10 may utilize any of a various number of well-known algorithms for ranking the responsive web pages 12-18, so that higher-ranked responsive web page 12 and 14, for example, are displayed earlier in a results summary page 26 on the laptop 20 than the lower-ranked responsive web page 18.

Several popular search engines rank the results of a query based in part on the number and quality of links that point to a particular web page that is responsive to the query. For example, if two websites—Website A and Website B—are each responsive to a query, and Website A has 10,000 other pages linking to it, while Website B only has 100 other pages of similar quality linking to it, then Website A would typically be ranked higher among the search results to the query.

In the past, webmasters have tried to artificially manipulate their page ranking through various means. For example, webmasters desiring a high rank would establish (or arrange to have established) several other web pages that link into their own web page. Thus, their own web page is more likely to attain a higher rank with respect to algorithms that reward numerous incoming links.

To address these situations, many search engines consider not only the number of such web page links, but also the quality of the links. For example, search engines may establish (through various means) a measure of trust for various specified websites, in turn, links from these relatively high-trust websites are considered to contribute more to a web site's rank than are links from relatively low-trust websites. Search engines typically assign a small weight, or no weight, to those web sites believed to be in the business of selling links for the purposes of search engine optimization, so as to make it difficult or impractical for a website with low ranking to pay for links in the name of search engine optimization.

Web page traffic may be increased by providing hyperlinks to the web site. For example, a common method of advertising is for an advertiser to pay a media publisher to display the advertiser's advertisement. One type of media publisher is a publisher of a web page. The advertiser benefits from the increased visibility provided by the media publisher. In this case, the advertisement may include a hyperlink back to the advertiser's web page to provide the increased web page traffic. In turn, the increased traffic often results in increased revenue which helps to pay the media publisher.

What is needed is a method for improving the ranking of an organization's web page by efficient use of the organization's funds.

### SUMMARY OF THE INVENTION

In one aspect of the present invention, a method suitable for facilitating a transaction between a donor and a recipient comprises the steps of: electronically matching the recipient to the donor based on at least one predetermined matching criterion; transferring at least a first portion of a donation amount from the donor to the recipient; and transmitting web content from a donor to the recipient in response to conditional acceptance by the recipient of at least the first portion of the donation amount.

In another aspect of the present invention, a computer-implemented method for facilitating a charitable contribution from a donor to a recipient comprises computer code for: matching the recipient to the donor based on at least one predetermined matching criterion; transferring a donation from the donor to the recipient; transmitting donor web content to the recipient in response to acceptance by the recipient of the donor donation; and embedding the donor web content on a web page of the recipient as a widget.

In yet another aspect of the present invention, a computer-readable storage medium has embodied thereon a program, the program being executable by a processor to perform a method for facilitating a transaction between a donor and a selected recipient, the method comprising the steps of: matching one or more recipients to the donor, based on at least one predetermined matching criterion, to produce a search result of candidate recipients; transferring a donation from the donor to a recipient selected from among the candidate recipients; transmitting donor web content to the selected recipient in response to acceptance by the selected recipient of the donor donation; and embedding the donor web content on a web page of the selected recipient as a widget subject to criteria specified by the selected recipient.

These and other features and advantages of the present invention will be more fully understood from the following detailed description with reference to the accompanying drawings.

### DESCRIPTION OF DRAWINGS

FIG. 1 is a schematic representation of a search performed on the Internet, in accordance with the present state of the art;

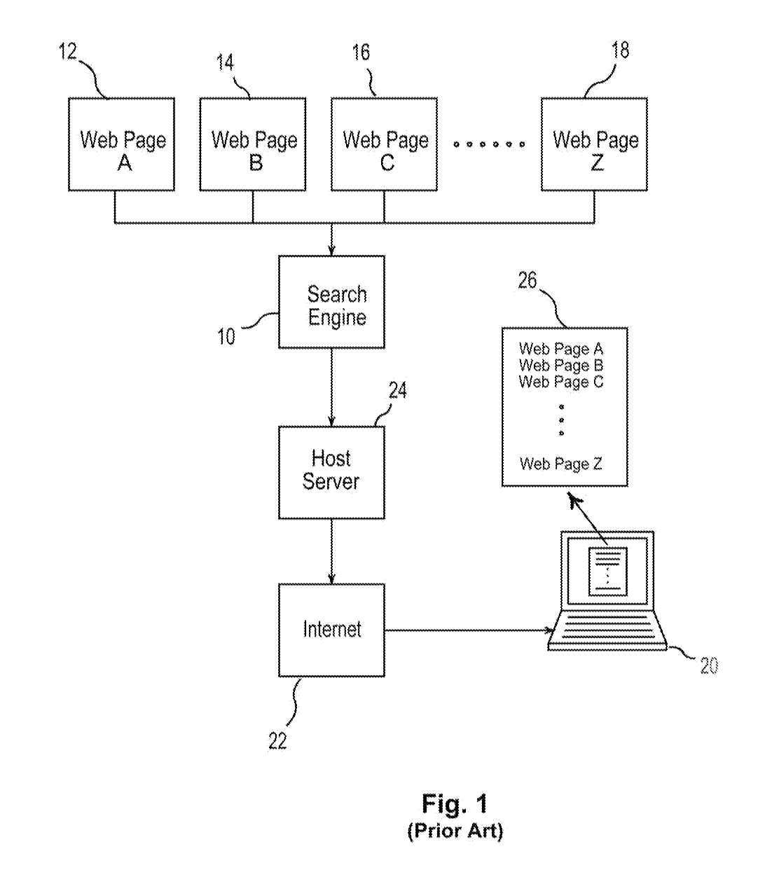

FIG. 2 is a diagrammatical representation of a donor initiating a donation using a donation platform, in accordance with the present invention;

FIG. 3 is an illustration of a computer being used by the donor for researching candidate recipients for receiving donations;

FIG. 4 is an illustration of a computer being used by the donor for accessing a recipient website and viewing an embedded donor widget;

FIG. 5 is a functional block diagram illustrating components of the donation platform of FIG. 2;

FIG. 6 is a diagram of the widget of FIG. 4 listing typical donor content components; and

FIG. 7 is a flow diagram illustrating the process by which a donor uses the donation platform of FIG. 2 to make one or more selected donations.

### DETAILED DESCRIPTION OF THE INVENTION

The present invention addresses the above problems by enabling an organization to boost its web page ranking by using a portion of its advertising and/or marketing funds to make charitable donations and generate high-quality links to the its web page as a result of the donations.

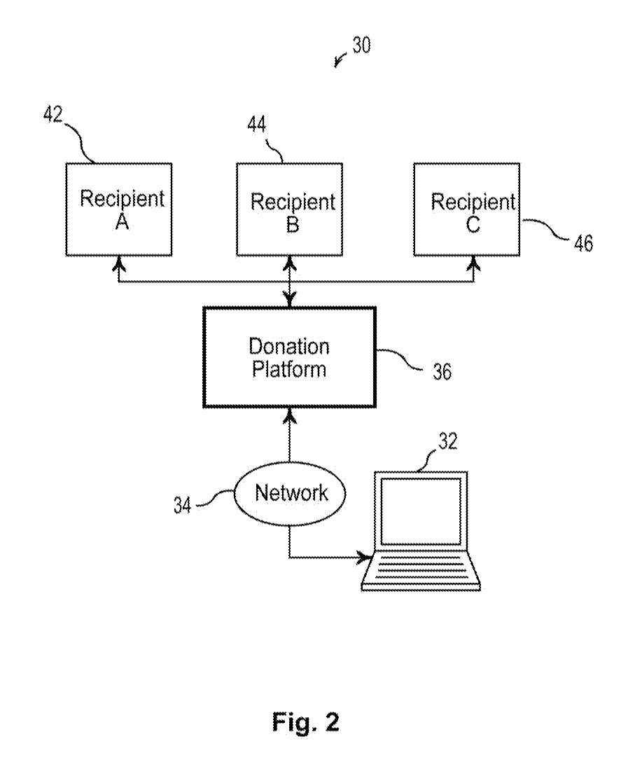

FIG. 2 is a functional schematic of a charitable donation facilitation system 30, in accordance with an aspect of the present invention. A potential donor may use Intranet or Internet network resources 34 via a communication device or computer, such as a laptop 32, the laptop 32 being in data communication with a donation platform 36. The donation platform 36 may be provided in a remote server (not shown). The donation platform 36 is also in data communication with one or more charitable organizations, here denoted as recipient A 42, recipient B 44, and recipient C 46. As can be appreciated by one skilled in the relevant art, these data communication capabilities may be implemented in any conventional manner, such as through a direct wired or wireless connection, or indirectly through a computer network, such as the Internet.

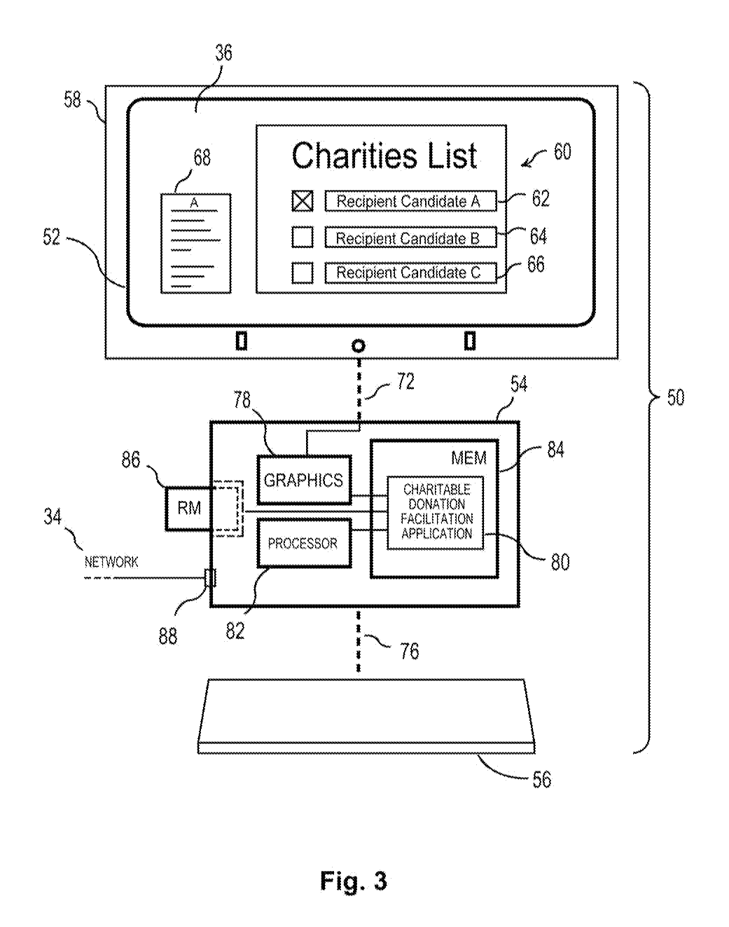

The donation platform 36 enables various donors, such as companies, individuals, and marketing firms acting on behalf of companies, to contribute to various recipients, such as charities, non-governmental organizations (NGOs), or other donation-supported entities, in a manner described more fully below. FIG. 3 is an illustration of a computer 50 being used by a donor to access the donor platform 36 and retrieve search results 60 for review on a display screen 52 of the computer 50.

In the embodiment shown, the computer 50 comprises a processing unit 54, an input keyboard 56, and a display unit 58, such as an LCD screen or a plasma screen. The processing unit 54 communicates with the display 58 via a display link 72, that may be wired or wireless. The display unit 58 functions to provide the display 52 to a user, as well known in the relevant art. The input keyboard 56 communicates with the processing unit 54 via an input link 76, that may be wired or wireless. In an alternative embodiment, the computer 50 may comprise a laptop device, a mobile phone, a notebook computer, a personal digital assistant, or any other mobile electronic device capable of communicating over a network.

The processing unit 54 may include a processor 82 operating to execute a charitable donation facilitation application 80, resident in a memory 84. The charitable donation facilitation application 80 may be implemented as a program, software, code, or other instructions stored in the memory 84. Alternatively, the memory 84 and the charitable donation facilitation application 80 may be provided as a single component, as a firmware chip (not shown), for example. A removable memory 86 and a network port 88 may be provided in the computer 50 for inputting data and software, as well known in the relevant art. The network port 88 may provide for an Ethernet connection as shown, for example, or may be a wireless port (not shown). The network port 88 may thus be used to communicate with any communication network such as the Internet, a Wide Area Network (WAN), a Local Area Network (LAN), an Intranet, an extranet, a private network, a public network, one or more mobile device networks, a combination of these networks, or other communication network.

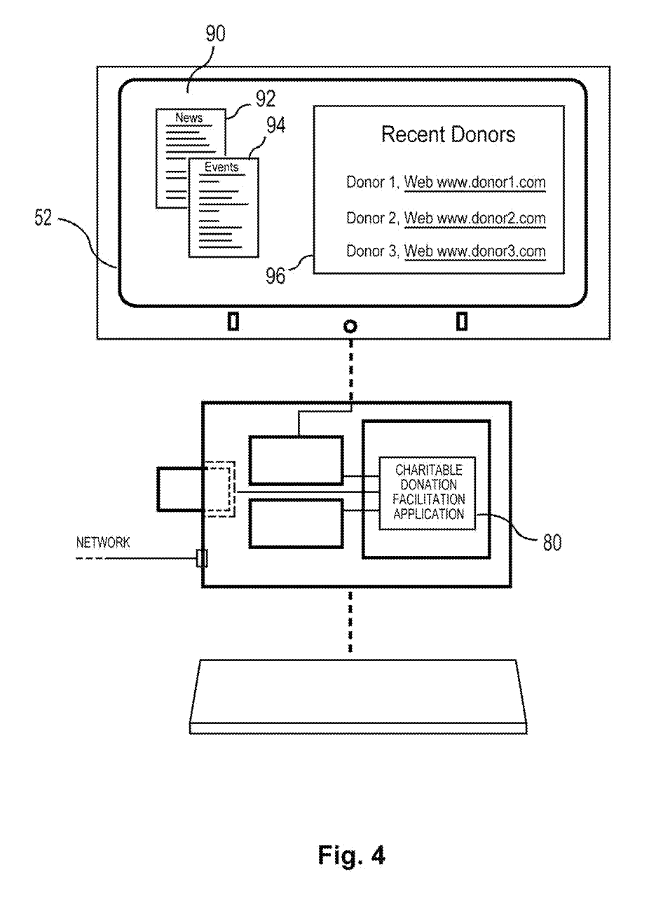

The charitable donation facilitation application 80 functions to provide the donor access, via the charitable donation facilitation system 30 described above, to recipient candidate selection fields 62, 64, and 66. The donor access serves to electronically connect the donor with charities, non-governmental organizations, and other donation-supported entities. In the example provided, the donor has selected recipient candidate A for a donation by marking a box in the field 62. An information window 68 may also be provided for the recipient candidates, here shown for recipient candidate A, explaining how the charitable donation might be used by the recipient. In an exemplary embodiment, the information window 68 may also include the recipient's conditions for accepting a particular donation. The donor would indicate acceptance of the conditions for acceptance by, for example, ‘clicking’ on a “accepts conditions” button (not shown). A graphics module 78 enables the donor to view in the user display 52 the donor search results 60 as well as a recipient home page 90 shown in FIG. 4. The recipient home page 90 may include various news related to recipient activities, such as a “News” content 92 and an “Events” content 94.

As a result of the donor contribution through the donation platform 36, recipient A 42, for example, may approve donor web content supplied by the donor to be embedded in a web page on a web site of the recipient A 42. As described more fully below, this web content is provided by the donor and may include a link back to a web page on a web site of the donor. Submission of the donor contribution to the recipient may thus result in the recipient providing a backlink from the recipient's web page back to the donor web page to increase the visibility of the donor web site on the Internet, and to thus improve the search ranking of the donor web page.

That is, the search engine 10, may detect this backlink in the ordinary course of its operation, such as when using crawlers or executing other automated processes. If the recipient's web site is regarded as trusted or, more generally, if the backlink provided in the recipient's web page is regarded as high-quality, then the presence of the trusted link may boost the page rank of the donor's web site during an online search. Thus, in response to queries from users, the search engine 10 may report the donor's web page higher in the search results 26 than it otherwise would have been were it not for the backlink in the recipient's web page.

The search engine 10 may continually develop and refine various algorithms to rank the results of a search. However, a conventional search engines is not likely to regard acknowledgement of donations of the type described herein as a dubious attribute when measuring the quality of such a backlink. Thus, by using the donation platform 36 as described herein to provide a donation from advertising or marketing budgets, the donor benefits by improving the page rank of the linked-to web page, and may well realize other benefits associated with the contribution, including tax benefits, generating positive publicity for the donor, and furthering the cause of the recipient. Moreover, the recipients benefit from participating in the donation platform 36 because they gain access to a pool of donors that may have otherwise been inaccessible to them.

FIG. 4 shows an exemplary web page 90, as could be hosted by a recipient using the donation platform 36 and the charitable donation facilitation application 80. In addition to the “News” content 92 and the “Events” content 94, the recipient web page 90 preferably includes an embedded widget 96 to acknowledge the donors and their respective donations made through the donation platform 36. The embedded widget 96 includes content supplied by one or more of the donors approved for listing by the recipient.

In the example shown, a plurality of donors, Donor 1, Donor 2, and Donor 3, are acknowledged in the embedded widget 96, and their respective web site URLs are provided in the user display 52. The donors shown in the embedded widget 96 may be the most recent donors, may be the most frequent donors, or may be the donors who gave the largest contributions, for example. In an exemplary embodiment, the donor may upload a one-page donor directory using file transfer protocol (FTP). As can be appreciated by one skilled in the relevant art, using FTP makes the uploaded donor directory accessible in most web technologies and to most organization websites.

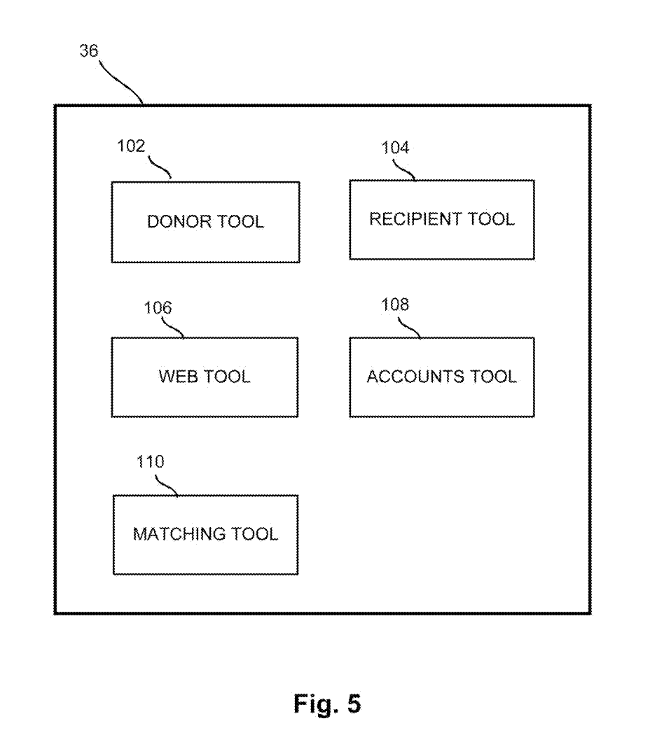

FIG. 5 is a functional block diagram of the donation platform 36. The donation platform 36 includes a donor tool 102, a recipient tool 104, a web tool 106, an accounts tool 108, and a matching tool 110. The component tools 102-110 of the donation platform 36 are in mutual data communication, either directly or indirectly through various other components (not shown for clarity of illustration) of the donation platform 36.

The donor tool 102 is operable to interface with various donors through the charitable donation facilitation application 80. The donor tool 102 functions to receive, to record and to retrieve information, and donor web page information in particular, provided by a prospective donor. Such information can include, for example, previous and current donation amounts, a list of recipients desired by the donor, frequency of donations made by the donor, donation matching criteria, and administrative information such as contact information of donor representatives.

The recipient tool 104 functions to receive, to record, and to retrieve information from prospective and existing recipients. Such information can include, for example, recipient web page characteristics, donation acceptance parameters, matching criteria, administrative information, and other relevant information that may be provided by the recipient. The web page characteristics may include web traffic statistics and trust measurements from various search engines. The donation acceptance parameters may include minimum donation for acknowledgement, and permitted or impermissible donor content.

The web tool 106 is operable to communicate electronically with other computers and communication devices using, for example, the computer 50 described above. In some implementations, the web tool 106 includes an HTML (hypertext transfer markup language) server, an FTP server, or the like. The web tool 106 may house and serve donor web content to the various recipient web pages. Alternatively or additionally, the web tool 106 may provide donor web content directly to recipients or their representatives for embedding in the recipient's web page(s). In an exemplary embodiment, the web tool 106 may function to allow one or more of the recipients to advertise to other donors that access the donation platform 36.

The accounts tool 108 functions to receive, to record, and to retrieve information pertaining to accounts of the donors and of the recipients. Such account information may include a total amount donated to a particular recipient or received from a particular donor, an aggregate amount donated or received, and the like. The accounts tool 108 is also operable to compute any other incidental fees associated with operating the donation platform 36, such as a periodic fee payable to donors or to recipients, a commission associated with a particular donation, and the like. The accounts tool 108 is operable to electronically implement financial transactions associated with donations, such as via electronic funds transfer, credit card transaction, or third-party payment facilities such as PayPal, or the like.

The matching tool 110 is operable to pair donors with prospective recipients, according to desired characteristics provided by the donor, the recipient, or by both. For example, the donor may desire to donate to a recipient that operates a web site with particular characteristics, such as exhibiting a particular amount of traffic, attracting Internet traffic in a particular geographic region, or showing activity in a particular demographic, for example. Similarly, a recipient may desire to conditionally acknowledge, such as acknowledging only donations with particular characteristics or donors with particular characteristics. The recipient may acknowledge only donations of a certain minimum amount, or may not accept donations from donors in particular industries or associated with particular causes. For example, a charitable organization soliciting donations for cancer research may not wish to publicly accept a prospective donation from a tobacco company. Additionally, recipients may provide constraints on the donor content, as explained in greater detail below.

The matching tool 110 can alternatively be configured to pair donors with recipients based on other factors. For example, if a donor can be paired with more than one recipient within the constraints set forth by the donor and the recipients, the matching toot 110 can identify a pairing that maximizes the revenue to the operator of the donation platform 36.

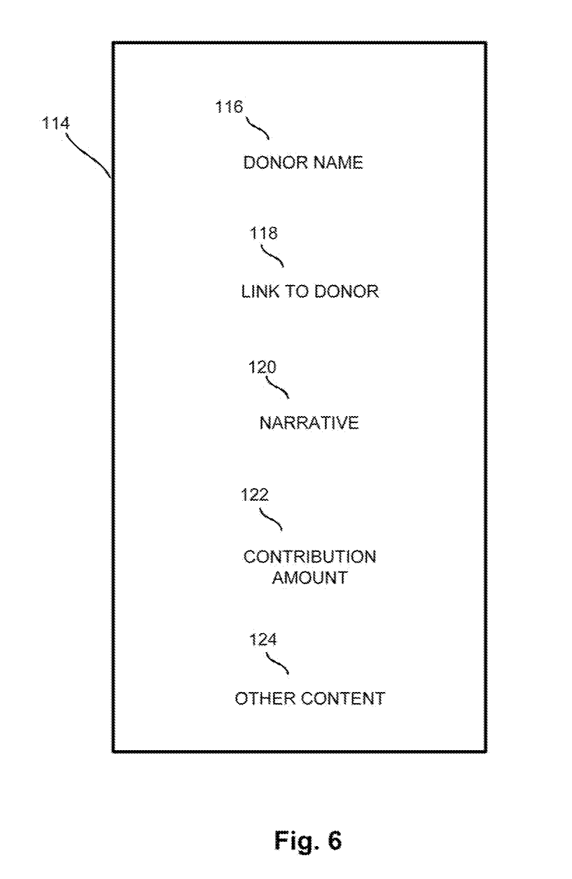

FIG. 6 is a schematic representation of donor web content 114. Subject to limitations described below, donor web content 114 can include the donor name 116, a link 118 to the donor, a narrative 120, a contribution amount 122, and other content 124. The narrative 120 may include relevant text prepared by the donor. For example, the narrative 120 may include a description of the donor organization, key products produced by a donor business entity, a statement in support of the recipient, and the like. In some implementations, the narrative 120 may require approval by a particular recipient before the narrative 120 can be included as the embedded widget 96 in the recipient's web page 90. The other content 124 may include any content that the donor may wish to display on a web page. This can include text, pictures, audio files, movies, animations, executable code, and the like. It should be understood that inclusion of the other content 124 may require approval by the recipient before placement in the recipient's web page.

The recipient may impose additional limitations on the submitted donor content 114. For example, the recipient may prohibit certain types of data formats or impose a word length on the narrative 120. In another example, the recipient may require a minimum donation amount in order to relax certain prohibitions. Thus, for example, donating a first amount may entitle the donor to a link and a fifty character narrative 120. Donating a second amount may entitle the donor to a link, one hundred characters for the narrative 120, and the use of a FLASH animation for the other content 124. Acceptance by the recipient may be an automatic process, for specified categories of donors, or the acceptance process may be entirely manual with an agent at a recipient's server evaluating potential donors.

Moreover, a recipient can display the donor web content 114 in a manner that depends at least in part on the donation. For example, donations may be acknowledged in the embedded widget 96 for a predetermined time period that depends, at least in part, on the donation amount. Similarly, the donor web content 114 corresponding to a relatively large donation may be displayed more prominently than other donor content emplaced in response to a relatively small donation. For example, donor web content corresponding to a large donation by the donor may be displayed on the front page of a recipient's web site, whereas donor web content corresponding to a lower donation by the donor may be displayed on an auxiliary page.

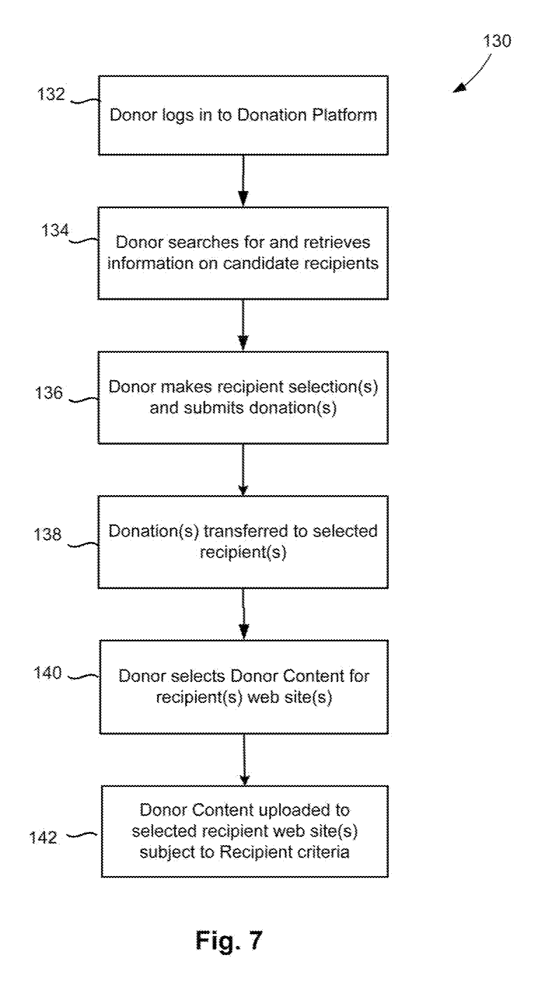

FIG. 7 is a flowchart 130 illustrating a method for implementing a donation, in accordance with an aspect of the present invention. In step 132, the donor may tog onto the donation platform 36 and be verified via the charitable donation facilitation application 80. In an exemplary embodiment, the donor may be identified by the matching tool 110, such as by verification or identified as residing in a donor queue that is being processed by the matching tool 110. Alternatively, a donor acceptable to a discriminating recipient can be identified by meeting predefined constraints provided by the discriminating recipient.

After logging on, the donor may electronically search for and retrieve information on one or more candidate recipients, at step 134. Preferably, the target recipient(s) can be identified by the matching tool 110 based on any specified criteria, such as being next in a recipient queue or by the recipient(s) meeting the desired demographic or traffic criteria provided by the donor. This process of matching recipients to the donor, based on at least one predetermined matching criterion, may produce a search result of one or more candidate recipients.

At step 136, the donor may select one or more recipients for donations from the search results, and submit the respective donations via the donor tool 102. The donation may be received in any manner, including: by electronic funds transfer, as a credit or debit card transaction, via a third party payment system such as PayPal, or by physical transfer of payment (e.g., receiving a check via a courier or postal service). The receipt of the donation may be verified by the accounts tool 108. In an exemplary embodiment, a plurality of donors may retain the services of a common agent to login a proxy for the donors and to make a simultaneous plurality of donations to one or more recipients on behalf of the plurality of donors.

At step 138, the one or more donations are transferred from, for example, an organization's advertising budget, to the corresponding recipient(s). As with receipt of the donation, this donation transfer can occur in any manner, such as described above. In an exemplary embodiment, an electronic transfer may be initiated by the accounts tool 108.

In some implementations, a portion of the originally-received donation may be retained by an operator of the donation platform 36. This retained portion can be a variable portion, a fixed fee, or a combination of both. The variable portion can be based on the amount of the donation (e.g., a percentage of the donation), and can be further based on other factors, such as the identity or characteristics of the recipient. For example, during a crisis such as a flood or earthquake, preferential treatment can be given to recipients that provide aid to those affected by the crisis.

In an exemplary embodiment, the transfer of the donation may made, but not made directly to the recipient. For example, various government or private entities may participate in a “matching” program, in which the government or private entity contributes some proportion of the donation to the recipient, beyond the original donation. If such a matching program is available, then step 138 may be modified accordingly so as to comply with such program requirements. In an alternative embodiment, the donor can transfer the donation directly to the recipient. In turn, the donor, the recipient, a third party, or a combination of the foregoing can be invoiced for a predetermined amount, via the donation platform 36.

In step 140, the donor selects the particular content, or information, related to the donor company that the donor wishes to embed in a page on the website of the selected recipient. This content is uploaded to the recipient site subject to criteria specified by the recipient, at step 142, such as by a file transfer protocol method, or otherwise made available to the recipient 14. The uploading function may also be provided by the web toot 106. The donor content can be uploaded to a pre-determined location on a computer (e.g., a web server) under the control of the recipient. Alternatively, the donor content can remain on a computer but not under the control of the recipient. For example, the donor content can remain on a computer associated with the donor, or the content can be hosted on a computer associated with the donation platform 36. In this case, the location of the content can be provided to the recipient for inclusion in the web page using HTML code or JavaScript programming.

While the foregoing drawings and description set forth functional aspects of the disclosed systems, no particular arrangement of software and/or hardware for implementing these functional aspects should be interred from these descriptions unless explicitly stated or otherwise clear from the context, and all such arrangements of software and/or hardware are intended to fall within the scope of this disclosure.

The above systems, devices, methods, processes, and the like may be realized in hardware, software, or any combination of these suitable for the control, data acquisition, and data processing described herein, such as in the computer 50 described above. This includes realization in one or more microprocessors, microcontrollers, embedded microcontrollers, programmable signal processors or other programmable devices or processing circuitry, along with internal and/or external memory. This may also, or instead, include one or more application specific integrated circuits, programmable gate arrays, programmable array logic components, or any other device or devices that may be configured to process electronic signals.

It will further be appreciated that a realization of the processes or devices described above may include computer-executable code created using a structured programming language such as C, an object oriented programming language such as C++, or any other high-level or low-level programming language including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as the various systems described above, or all of the functionality may be integrated into a dedicated, standalone device. All such permutations and combinations are intended to fall within the scope of the present disclosure.

In some embodiments disclosed herein are computer program products comprising computer-executable code or computer-usable code that, when executing on one or more computing devices (such as the devices/systems described above), performs any and/or all of the steps described above. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the processes described above may be embodied in any suitable transmission or propagation medium carrying the computer-executable code described above and/or any inputs or outputs from same.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

While particular embodiments of the present invention have been shown and described, it will be apparent to those skilled in the art that various changes and modifications in form and details may be made therein without departing from the spirit and scope of the invention as defined by the following claims. The claims that follow are intended to include all such variations and modifications that might fall within their scope, and should be interpreted in the broadest sense allowable by law.

What is claimed is:

1. A method suitable for facilitating a transaction between a donor and a recipient, said method comprising the steps of
electronically matching the recipient to the donor based on at least one predetermined matching criterion;
transferring at least a first portion of a donation amount from the donor to the recipient; and
transmitting donor web content from the donor to the recipient in response to conditional acceptance by the recipient of said at least a first portion of said donation amount.

2. The method as in claim 1 wherein said step of matching comprises the step of logging on to a donation platform to perform a recipient search based on said at least one predetermined matching criterion.

3. The method as in claim 2 further comprising the step of transferring a second portion of said donation amount from the donor to an operator of said donation platform.

4. The method as in claim 1 further comprising the step of embedding said donor web content in a web page of the recipient in response to said step of transmitting said donor web content.

5. The method as in claim 4 wherein said donor web content is uploaded to said recipient web page by file transfer protocol.

6. The method as in claim 4 wherein said donor web content comprises an embedded widget in said web page.

7. The method as in claim 2 wherein said donation platform comprises at least one of a donor tool, a recipient tool, a web tool, an accounts tool, and a matching tool.

8. The method as in claim 7 wherein said donor tool is operable to interface with various donors to receive, to record or to retrieve information provided by a prospective donor.

9. The method as in claim 7 wherein said recipient tool functions to receive, to record, or to retrieve information from prospective and existing recipients, said information comprising at least one of: recipient web page characteristics, donation acceptance parameters, matching criteria, and administrative information.

10. The method as in claim 7 wherein said web tool is operable to communicate electronically with computers and communication devices via at least one of a hypertext transfer markup language server and a file transfer protocol server.

11. The method as in claim 7 wherein said accounts tool functions to receive, to record, or to retrieve information pertaining to donor financial accounts or to recipient financial accounts.

12. The method as in claim 7 wherein said matching tool is operable to pair donors with prospective recipients according to desired characteristics provided by the donor, by the recipient, or by both the donor and the recipient.

13. The method as in claim 1 wherein said conditional acceptance is not granted for at least one of: a donation below a specified minimum amount, a donation from a donor in a specified industry, and a donation from a donor associated with a specified cause.

14. The method as in claim 1 wherein said donor web content comprises at least one of: a donor name, a link to the donor, a narrative, a contribution amount, and text prepared by the donor.

15. The method as in claim 1 wherein said donation is acknowledged in a web page of the recipient for a predetermined time period, said predetermined time period being a function of at least one of: a donation amount, a donation size, and frequency of donation.

16. The method as in claim 1 further comprising specified limitations on said donor content, said specified limitations including at least one of: a prohibition of specified types of data formats in said donor content and a maximum allowable word length on a narrative in said donor content.

17. The method as in claim 1 wherein said step of transmitting further comprises the recipient requiring a minimum donation amount.

18. A computer-implemented method for facilitating a charitable contribution from a donor to a recipient, said computer-implemented method comprising computer-readable code for performing the steps of:
matching the recipient to the donor based on at least one predetermined matching criterion;
transferring a donation from the donor to the recipient;
transmitting donor content to the recipient in response to acceptance by the recipient of said donor donation; and
subject to a criterion specified by the recipient, embedding said donor content on a web page of the recipient as a widget.

19. The computer-implemented method as in claim 18 wherein said criterion comprises a member of the group consisting of: a donation below a specified minimum amount, a donation from a donor in a specified industry, a donation from a donor associated with a specified cause, a donation above a specified amount, a donation of a specified size, and a specified frequency of donations.

20. A computer-readable storage medium having embodied thereon a program, the program being executable by a processor to perform a method for facilitating a transaction between a donor and a selected recipient, said method comprising the steps of:
matching one or more recipients to the donor, based on at least one predetermined matching criterion, to produce a search result of candidate recipients;
transferring a donation from the donor to a recipient selected from among said candidate recipients;
transmitting donor web content to said selected recipient in response to acceptance by said selected recipient of said donor donation; and
embedding said donor web content on a web page of said selected recipient as a widget subject to criteria specified by said selected recipient.
